(19) United States
(12) Patent Application Publication
(10) Pub. No.: US 2007/0218766 A1
(43) Pub. Date: Sep. 20, 2007

(54) DUAL DIFFERENTIAL PAIR CABLE

(75) Inventor: YU-HSU LIN, San Jose, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,800

(22) Filed: Sep. 28, 2006

(30) Foreign Application Priority Data
Mar. 14, 2006 (CN) 200610034463.5

(51) Int. Cl. H01R 9/03

(52) U.S. Cl. 439/610

(57) ABSTRACT

A dual differential pair cable includes a jacket, a plurality of wires electrically insulated from each other and surrounded by the jacket, and a header connector having a plurality of receptacles each connected to a corresponding wire. The plurality of receptacles includes a first receptacle pair connected to a first differential pair of the wires and a second receptacle pair connected to a second differential pair of the wires. The pairs of receptacles are so arranged that straight lines from a center of one of the first receptacle pair to a center of another of the first receptacle pair and from a center of one of the second receptacle pair to a center of another of the second receptacle pair are mutually perpendicularly bisecting.

### FIELD OF THE INVENTION

The present invention relates to a cable, and particularly to a dual differential pair cable.

### DESCRIPTION OF RELATED ART

Differential pair cables are popularly used in computer systems. For example, both universe serial bus (USB) interface and IEEE 1 394 interfaces transmit signals with corresponding dual differential pair cables. Referring to FIG. 3 and FIG. 4, a conventional dual differential pair cable for a USB interface includes a 2×5 header connector 12, a jacket 14, and a plurality of wires 16. The wires 16 are electrically insulated from each other and surrounded by the jacket 14. A bottom side 121 of the connector 12 is in the form of a rectangle. Receptacles 1˜9 are arranged in two rows in the connector 12. Receptacles 1˜8 are respectively electrically connected to wires 16. A wire assignment 1˜9 of the 2×5 header connector 12 is shown as Table 1. Wherein receptacles 3, 5 and receptacles 4, 6 are respectively connected to a first differential pair of the wires 16 and a second differential pair of the wires 16. Each pair of the first and second differential pairs of the wires 16 has two wires with opposite signal transmitting directions. “NC” symbolizes the receptacle 9 is not connected.

TABLE I

| Receptacle | Wire assignment |
|---|---|
| 1 | Power signal |
| 2 | Power signal |
| 3 | A− |
| 4 | B− |
| 5 | A+ |
| 6 | B+ |
| 7 | Ground signal |
| 8 | Ground signal |
| 9 | NC |

However, due to such arrangement of the receptacles 1˜9, differential signals A−, A+ respectively transmitted in receptacles 3, 5 and differential signals B−, B+ respectively transmitted in receptacles 4, 6 can interact, causing crosstalk and reduced performance of the signal transmitting of the dual differential pair cable.

What is needed, therefore, is a dual differential pair cable that may reduce the crosstalk.

### SUMMARY OF THE INVENTION

A dual differential pair cable for reducing crosstalk is provided. In a preferred embodiment, the dual differential pair cable includes a jacket, a plurality of wires electrically insulated from each other and surrounded by the jacket, and a header connector having a plurality of receptacles each connected to a corresponding wire. The plurality of receptacles includes a first receptacle pair connected to a first differential pair of the wires and a second receptacle pair connected to a second differential pair of the wires. The pairs of receptacles are so arranged that straight lines from a center of one of the first receptacle pair to a center of another of the first receptacle pair and from a center of one of the second receptacle pair to a center of another of the second receptacle pair are mutually perpendicularly bisecting.

Other advantages and novel features will become more apparent from the following detailed description when taken in conjunction with the accompanying drawings, in which:

### BRIEF DESCRIPTION OF THE DRAWINGS

FIG. 1 is an isometric, schematic diagram of a dual differential pair cable, in accordance with a preferred embodiment of the present invention;

FIG. 2 is a front view of FIG. 1;

FIG. 3 is an isometric, schematic diagram of a conventional dual differential pair cable; and

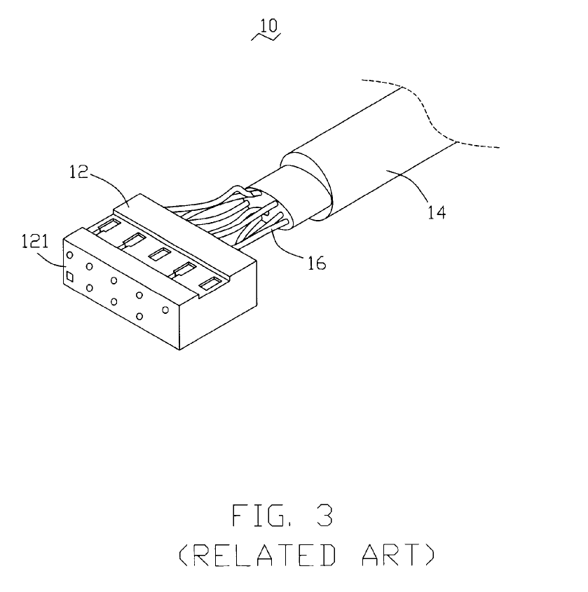

FIG. 4 is a front view of FIG. 3.

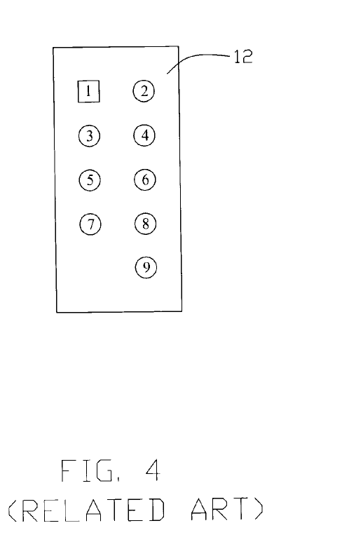

### DETAILED DESCRIPTION OF THE INVENTION

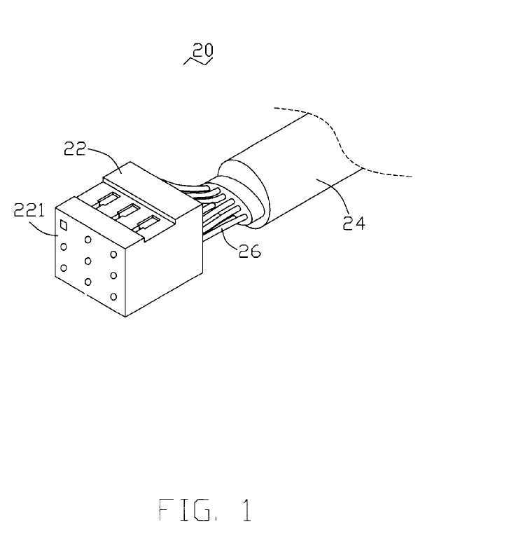

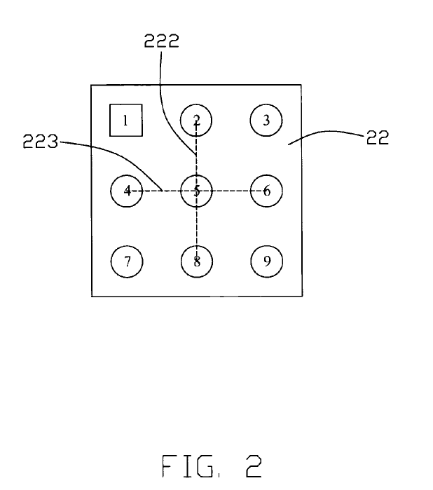

Referring to FIG. 1 and FIG. 2, a dual differential pair cable 20 in accordance with a preferred embodiment of the present invention includes a header connector 22, a jacket 24, and a plurality of wires 26. The wires 26 are electrically insulated from each other and surrounded by the jacket 24. A bottom side 221 of the connector 22 can be in form of a geometrical shape such as a square, a circle, or other desired geometrical shape at a designer's choice. For example, in the embodiment as shown in FIG. 1, the bottom side 221 is in the form of a square. Receptacles 1˜9 are arranged in three rows in the connector 22 with each row having three receptacles. Receptacles 1˜4, and receptacles 6˜9 are respectively electrically connected to wires 16. A wire assignment 1˜9 of the connector 22 is shown as Table II. Wherein a first receptacle pair 2, 8 and a second receptacle pair 4, 6 are respectively connected to a first differential pair of the wires 26 and a second differential pair of the wires 26. Each pair of the first and second differential pairs of wires 26 has two wires with opposite signal transmitting direction. “NC” symbolizes the receptacle 5 is not connected.

TABLE II

| Receptacle | Wire assignment |
|---|---|
| 1 | Power signal |
| 2 | A+ |
| 3 | Ground signal |
| 4 | B+ |
| 5 | NC |
| 6 | B− |
| 7 | Ground signal |
| 8 | A− |
| 9 | Power signal |

The first receptacle pair 2, 8 and the second receptacle pair 4, 6 are so arranged that a straight line 222 from a center of one of the first receptacle pair 2, 8 to a center of another of the first receptacle pair 2, 8 and a straight line 223 from a center of one of the second receptacle pair 4, 6 to a center of another of the second receptacle pair 4, 6 are mutually perpendicularly bisecting. The intersection between the straight line from a center of one of the first receptacle pair 2, 8 to a center of another of the first receptacle pair 2, 8 and the straight line from a center of one of the second receptacle pair 4, 6 to a center of another of the second receptacle pair 4, 6 is located at a center of the receptacle 5. Distances from the pairs of receptacles 2, 8, 4, 6 to a center of an arrangement of the receptacles 1-9 are the same. In such an receptacle arrangement, the crosstalk between differential signals A+, A− respectively transmitted in the first receptacle pair 2, 8 and differential signals B+, B− respectively transmitted in the second receptacle pair 4, 6 is greatly reduced.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A dual differential pair cable comprising:
a jacket;
a plurality of wires electrically insulated from each other and surrounded by the jacket; and
a header connector having a plurality of receptacles each connected to a corresponding wire, the plurality of receptacles comprising a first receptacle pair connected to a first differential pair of the wires and a second receptacle pair connected to a second differential pair of the wires, wherein the pairs of receptacles are so arranged that straight lines from a center of one of the first receptacle pair to a center of another of the first receptacle pair and from a center of one of the second receptacle pair to a center of another of the second receptacle pair are mutually perpendicularly bisecting.

2. The dual differential pair cable as claimed in claim 1, wherein the header connector comprises a bottom side in the form of a square.

3. The dual differential pair cable as claimed in claim 1, wherein each pair of the first and second differential pairs of wires has two wires with opposite signal transmitting directions.

4. The dual differential pair cable as claimed in claim 1, wherein the plurality of receptacles are arranged in three rows in the header connector, with each row having three receptacles.

5. A receptacle arrangement of a header connector, the receptacle arrangement comprising:
a first receptacle pair located in the header connector and connected to a first differential pair of wires; and
a second receptacle pair located in the header connector and connected to a second differential pair of wires, the pairs of receptacles being so arranged that straight lines from
a center of one of the first receptacle pair to a center of another of the first receptacle pair and from a center of one of the second receptacle pair to a center of another of the second receptacle pair are mutually perpendicularly bisecting.

6. The receptacle arrangement as claimed in claim 5, wherein the header connector comprises a bottom side in the form of a square.

7. The receptacle arrangement as claimed in claim 5, wherein each pair of the first and second differential pairs of wires has two wires with opposite signal transmitting directions.

8. The receptacle arrangement as claimed in claim 5, further comprising additional receptacles cooperating with the pairs of receptacles arranged in three rows in the header connector, with each row having three receptacles.

9. The receptacle arrangement as claimed in claim 8, wherein the intersection between the straight line from a center of one of the first receptacle pair to a center of another of the first receptacle pair and the straight line from a center of one of the second receptacle pair to a center of another of the second receptacle pair is located at a center of one of the receptacles located at a center of the arrangement.

10. A dual differential pair cable comprising:
a jacket;
a plurality of wires electrically insulated from each other and surrounded by the jacket; and
a header connector having a plurality of receptacles each connected to a corresponding wire, the plurality of receptacles comprising a first receptacle pair connected to a first differential pair of the wires and a second receptacle pair connected to a second differential pair of the wires, wherein distances from the pairs of receptacles to a center of an arrangement of the receptacles are the same.
